(19) United States
(12) Patent Application Publication
(10) Pub. No.: US 2011/0220638 A1
(43) Pub. Date: Sep. 15, 2011

(54) FINNED CERAMIC HEATER

(75) Inventors: Chih-Chang WEI, Ying Ko (TW); Etsuro HABATA, Ying Ko (TW)

(73) Assignee: BETACERA INC.

(21) Appl. No.: 12/723,789

(22) Filed: Mar. 15, 2010

(51) Int. Cl. H05B 3/02

(52) U.S. Cl. 219/550

(57) ABSTRACT

A finned ceramic heater includes a ceramic heating assembly, a pair of electrode plates, a plurality of insulating pieces, an insulating adhesive, and a pair of fins. The pair of electrode plates is adhered to both side surfaces of the ceramic heating assembly respectively. The insulating pieces are connected in series and adhered to an outer surface of each electrode plate respectively. A seam is formed between two adjacent insulating pieces. The width of the insulating piece is larger than that of the electrode plate. The insulating adhesive is filled in the seam. Each of the fins is disposed on the insulating pieces and the insulating adhesive. With this arrangement, a larger tolerance in the thickness of each insulating piece can be obtained, thereby preventing the insulating pieces from cracking due to their inconsistent flatness and enhancing the insulating property of the heater.

### BACKGROUND OF THE INVENTION

1. Field of the Invention

The present invention relates to a heater, and in particular to a finned ceramic heater.

2. Description of Prior Art

When a positive temperature coefficient (PTC) ceramic is supplied with electricity, its resistance will increase rapidly with the temperature in a certain range of temperature, so that the PTC ceramics can be widely used in thermostat heaters, household appliances, automobile heating and protection lines or the like. The PTC ceramics are made by adding rare earth elements into barium carbonate or titanium dioxide and sintering the above mixture at high temperature. The resistance of the PTC ceramic can be maintained low in a wide range of temperature. When the temperature of the PTC ceramic exceeds the Curie temperature, the resistance of the PTC ceramic will increase to a larger extent rapidly.

A conventional heater has a positive temperature coefficient (PTC) ceramic resistor, both surfaces of which are adhered with an electrical-conductive metallic piece. The electrical-conductive metallic piece has an electrical-conductive terminal electrically connected to an external power source thus to obtain electricity. The electric current flows through the two electrical-conductive metallic pieces and the PTC ceramic resistor, so that the PTC ceramic resistor will generate heat. The amount of heat generated equals to the product of the electric current and the square of the resistance of the PTC ceramic resistor. Since the contact area between a thermal-conducting area and the outside is not large enough, the amount of heat that can be dissipated is insufficient. Thus, one side of the electrical-conductive metallic piece is provided with fins for conducting the heat generated by the PTC ceramic resistor and for electrically insulating from the outside for better safety. An insulating plate is sandwiched between the fins and the electrical-conductive metallic piece for obstructing an electric current of the electrical-conductive metallic piece from flowing to the fins. However, since the flatness of the fins, the electrical-conductive metallic piece, and the insulating plate are different, the stress on the insulating plate may be distributed unevenly, which makes the insulating plate to generate cracks so as to reduce the insulating property of the insulating plate.

In view of the above problems, the present inventor proposes a reasonable and novel structure based on his expert experience and delicate researches.

### SUMMARY OF THE INVENTION

The present invention is to provide a finned ceramic heater, which is capable of enhancing the insulating property of the heater.

The present invention is to provide a finned ceramic heater, which includes a ceramic heating assembly, a pair of electrode plates, a plurality of insulating plates, an insulating adhesive, and a pair of fins. The pair of electrode plates is adhered to both side surfaces of the ceramic heating assembly respectively. The insulating pieces are connected in series and adhered to outer surfaces of the pair of electrode plates. A seam is formed between two adjacent insulating pieces. The width of the insulating piece is larger than that of the electrode plate. The insulating adhesive is filled in the seam. The pair of fins is disposed on the insulating pieces and the insulating adhesive.

The present invention has advantageous features as follows. The insulating pieces are connected in series and sandwiched tightly between the electrode plates and the fins, thereby generating a larger tolerance in the thickness of the insulating pieces and preventing the insulating pieces from cracking due to their inconsistent flatness.

### BRIEF DESCRIPTION OF THE DRAWINGS

FIG. 1 is an exploded perspective view of the present invention;

FIG. 2 is an assembled perspective view of the present invention;

FIG. 3 is a front view of the present invention;

FIG. 4 is a side view of the present invention;

FIG. 5 is a first mode of connection between the insulating pieces of the present invention;

FIG. 6 is a second mode of connection between the insulating pieces of the present invention;

FIG. 7 is a third mode of connection between the insulating pieces of the present invention;

FIG. 8 is a schematic view showing the covering of the insulating glue in the present invention;

FIG. 9 is a schematic view showing the covering of the insulating frame in the present invention;

FIG. 10 is a schematic view showing another embodiment of the insulating block of the present invention;

FIG. 11 is an assembled view showing the insulating block of FIG. 10;

FIG. 12 is a schematic view showing another aspect of the insulating piece of the present invention; and

FIG. 13 is an assembled perspective view of FIG. 12.

### DETAILED DESCRIPTION OF THE INVENTION

The characteristics and technical contents of the present invention will be described with reference to the accompanying drawings. However, the drawings are illustrative only, but not used to limit the present invention.

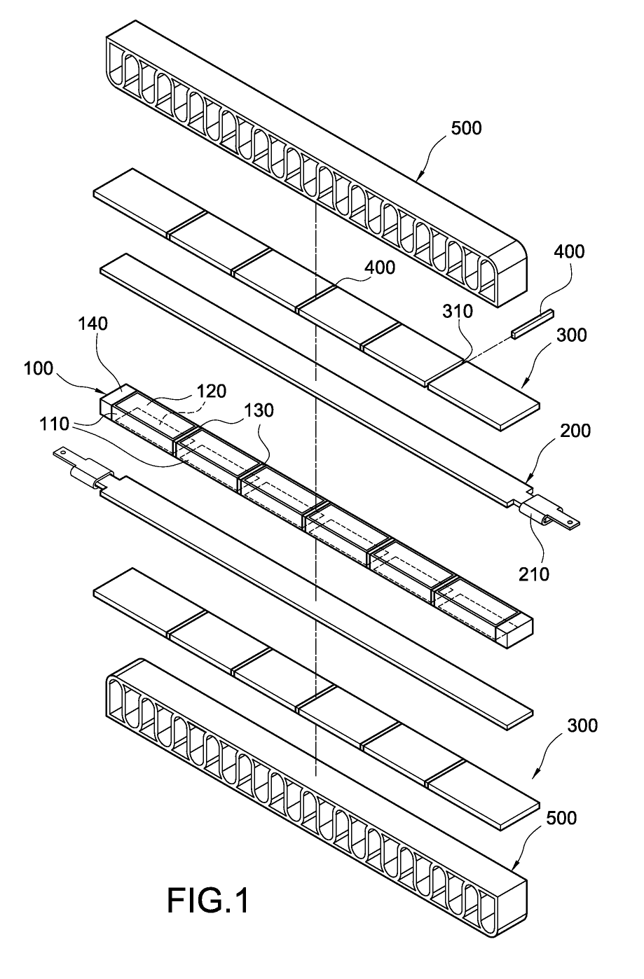

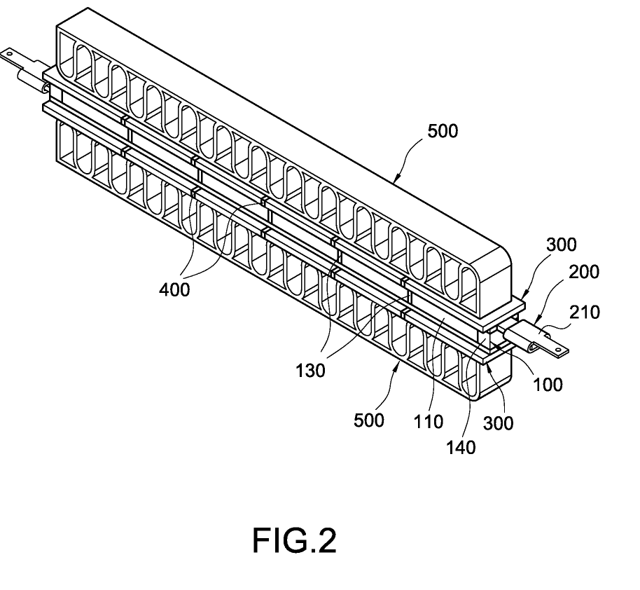

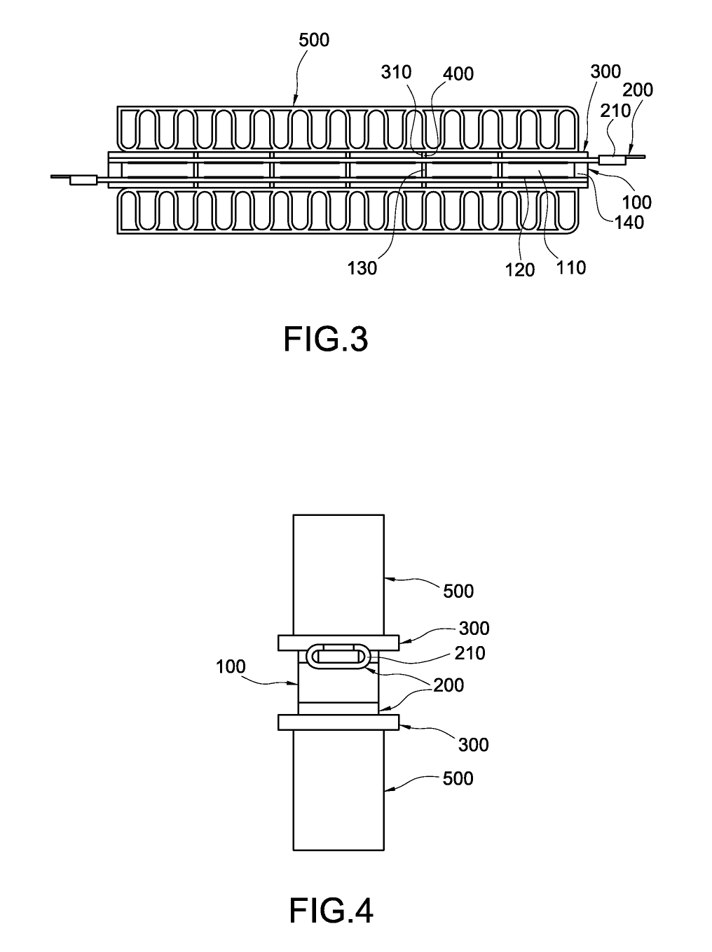

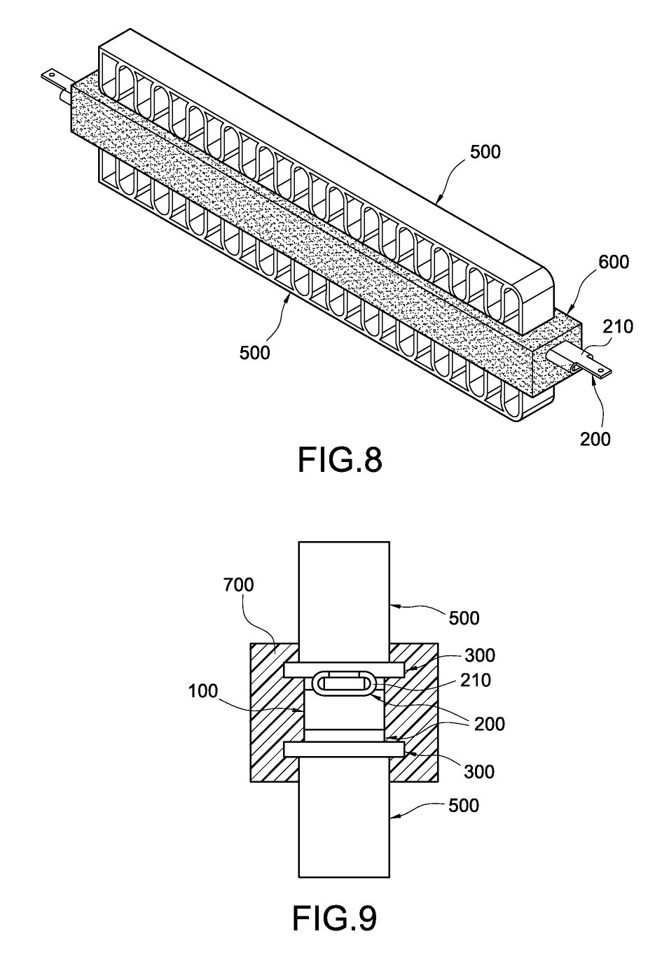

Please refer to FIGS. 1 to 7. The present invention provides a finned ceramic heater which includes a ceramic heating assembly 100, a pair of electrode plates 200, a plurality of insulating pieces 300, an insulating adhesive 400, a pair of fins 500, and insulating glue 600 (FIG. 8).

The ceramic heating assembly 100 comprises a plurality of PTC ceramic heating pieces 110 connected in series. The top surface and the bottom surface of each PTC ceramic heating piece 110 are coated with an electrode layer 120. The electrode layer 120 is made of electrical-conductive materials such as aluminum (but not limited thereto). Since the resistance of the PTC ceramic heating piece 110 is very large, an electric current cannot flow through the PTC ceramic heating piece 110. The electrode layer 120 can slightly reduce the resistance of the PTC ceramic heating piece 110 to allow the electric current to flow there through. In this way, the PTC ceramic heating piece 110 can generate heat. An insulating gel 130 is filled between two adjacent PTC ceramic heating pieces 110 for obstructing the electrode layers 120 respectively coated on the top surface and the bottom surface of each PTC ceramic heating piece 110 from generating an electric-arc short circuit. In case of a short circuit, the PTC ceramic heating piece 110 cannot generate heat. The ceramic heating assembly 100 further comprises an insulating block 140 adhered to the distal end of the outmost PTC ceramic heating piece 110, or sandwiched between two adjacent PTC ceramic heating pieces 110 (not exclusively) for enhancing the electrical insulation. The insulating block 140 is made of insulating materials such as aluminum oxide, silicon nitride, aluminum nitride or the like (but not limited thereto). The comparative tracking index (CTI) of the insulating block 140 is not less than 600. The CTI is used to measure the electrical breakdown (tracking) properties of an insulating material, and its value is equal to the voltage caused by the leakage of electricity.

The pair of electrode plates 200 is adhered to the top surface and the bottom surface of the ceramic heating assembly 100 respectively. That is, the PTC ceramic heating pieces 110 are sandwiched between the pair of electrode plates 200. The electrode plate 200 is made of electrical-conductive materials such as aluminum (but not limited thereto). The pair of electrode plates 200 is electrically connected to the electrode layers 120 respectively, so that the electric current can flow through the electrode plate 200 and the PTC ceramic heating pieces 110 more easily. Further, since the electrode layer 120 and the electrode plate 200 are made of the same electrical-conductive material such as aluminum. Displacement of atoms or migration of electrons may not happen between the electrode layer 120 and the electrode plate 200. The pair of electrode plates 200 has an electrical-conductive terminal 210 respectively. The pair of electrical-conductive terminals 210 is electrically connected to a positive pole and a negative pole of an external power source respectively. The electrical-conductive terminals 210 extend in opposite directions, so that the pair of the electrical-conductive terminals 210 can be prevented from getting too close to generate a short circuit when the terminals are electrically connected to the external power source. Since the ceramic heating assembly 100 has a plurality of PTC ceramic heating pieces 110 connected in series and tightly sandwiched between the pair of electrode plates 200, such an arrangement can generate a larger tolerance in the thickness of the PTC ceramic heating pieces 110, so that the PTC ceramic heating pieces 110 may not crack due to inconsistent flatness.

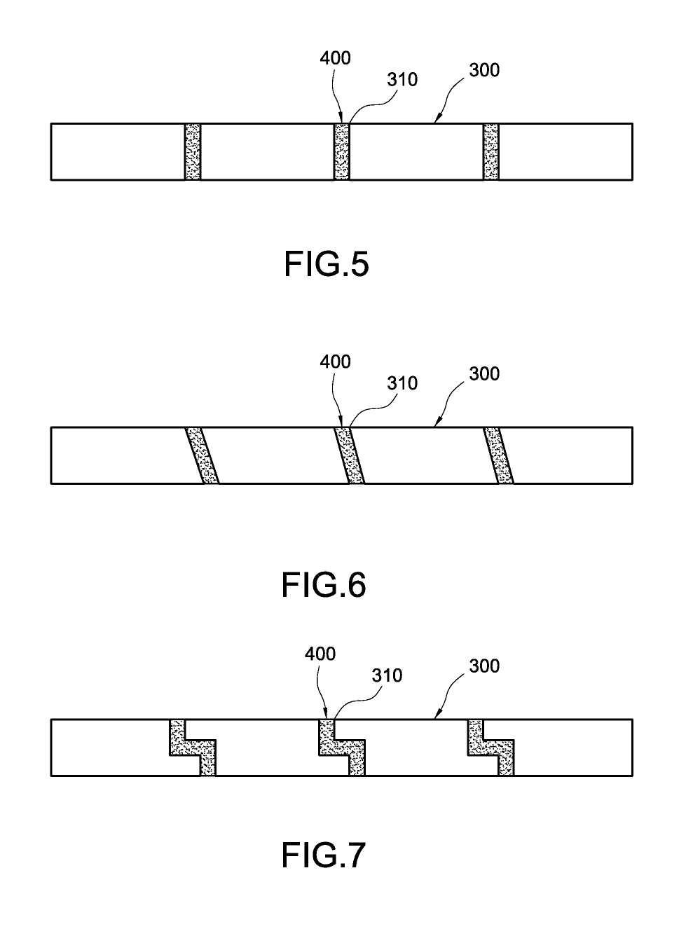

The insulating pieces 300 are connected in series and adhered to outer surfaces of the pair of electrode plates 200. The width of each insulating piece 300 is larger than that of the electrode plate 200 (FIG. 4), thereby avoiding from generating an electric arc. The end surface of the insulating piece 300 may be a vertical surface, an inclined surface or a stepped surface, whereby two adjacent insulating pieces 300 can be connected with each other (as shown in FIGS. 5 to 7). A seam 310 is formed between two adjacent insulating pieces 300. The insulating piece 300 is made of insulating materials such as aluminum oxide, silicon nitride, aluminum nitride or the like (but not limited thereto). The number of the insulating pieces 300 can be identical to that of the PTC ceramic heating pieces 110, and the insulating pieces 300 are positioned to correspond to the PTC ceramic heating pieces 110.

The insulating adhesive 400 is filled in the seam 310, thereby tightly binding two adjacent insulating pieces 300 and enhancing the insulating property among the insulating pieces 300 after combination. Further, when the heater is in operation, the insulating pieces 300 will expand when it's hot and contract when it's cold. Since the insulating pieces 300 are tightly bound to each other by the insulating adhesive 400, the deformation caused by the thermal expansion or contraction can be reduced.

The pair of fins 500 is disposed on the outer surfaces of the insulating pieces 300 and the insulating adhesive 400. That is, the fins 500 and the electrode plates 200 sandwich the insulating pieces 300 and the insulating adhesive 400. Further, the width of the insulating piece 300 is larger than the width of the fins 500 (FIG. 4), thereby preventing from generating an electric arc and preventing an electric current from flowing to the fins 500 from the electrode plates 200. In this way, the insulating property of the whole heater can be enhanced. Further, the fins 500 can enhance the heat-dissipating effect of the heater. That is, the heating capacity of the heater can be enhanced. Further, since the insulating pieces 300 are connected in series and tightly sandwiched between the electrode plates 200 and the fins 500, such an arrangement can generate a larger tolerance in the thickness of the insulating pieces 300, so that the insulating pieces 300 may not crack due to inconsistent flatness.

In use, the electric current enters the heater from one of the electrical-conductive terminals 210, and then sequentially flows through the electrode plate 200 and the electrode layer 120 on the same side, the PTC ceramic heating pieces 110, the electrode layer 120 and the electrode plate 200 on the other side, and finally exits the heater through the other electrical-conductive terminal 210. Since the electric current flows through the PTC ceramic heating pieces 110, the amount of heat generated by the PTC ceramic heating pieces 110 equals to the product of the electrical current and the square of the resistance of the PTC ceramic heating pieces 110. The heat generated by the PTC ceramic heating pieces 110 is conducted through the electrode layers 120, the electrode plates 200, the insulating pieces 300, and the fins 500 on both sides. Finally, the heat is conducted to the outside by means of the high thermal conductivity of the fins 500.

Please refer to FIG. 8. The finned ceramic heater further includes insulating glue 600. The insulating glue 600 covers the ceramic heating assembly 100, the pair of electrode plates 200, and the periphery of the insulating pieces 300, thereby enhancing the insulating property and the moist-proof effect of the whole heater.

Please refer to FIG. 9. The finned ceramic heater further includes a pair of insulating frames 700 formed into an “E” shape. The insulating frames 700 cover the ceramic heating assembly 100, the pair of electrode plates 200, and the periphery of the insulating pieces 300, thereby enhancing the insulating property of the whole heater.

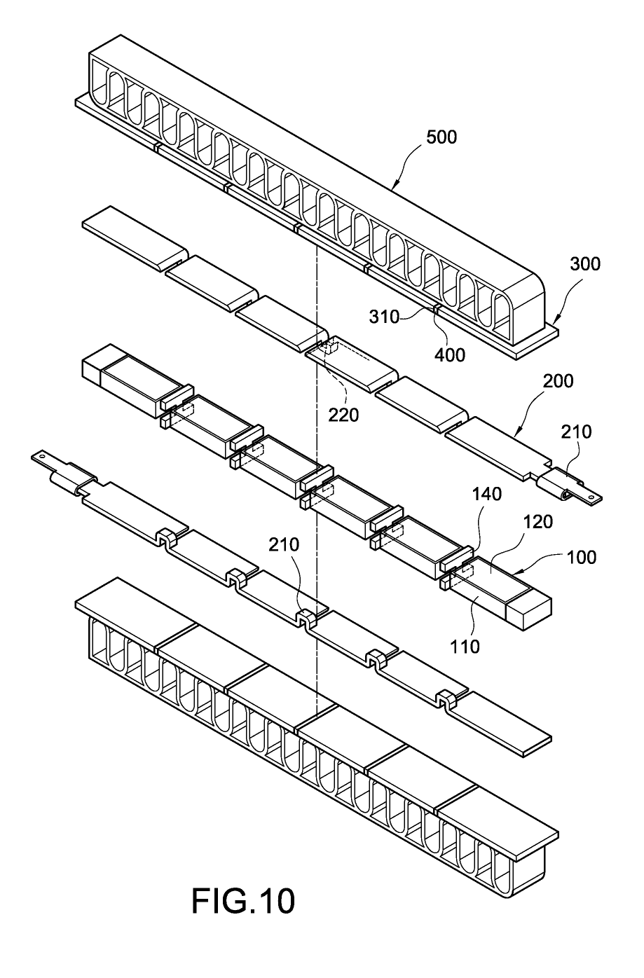

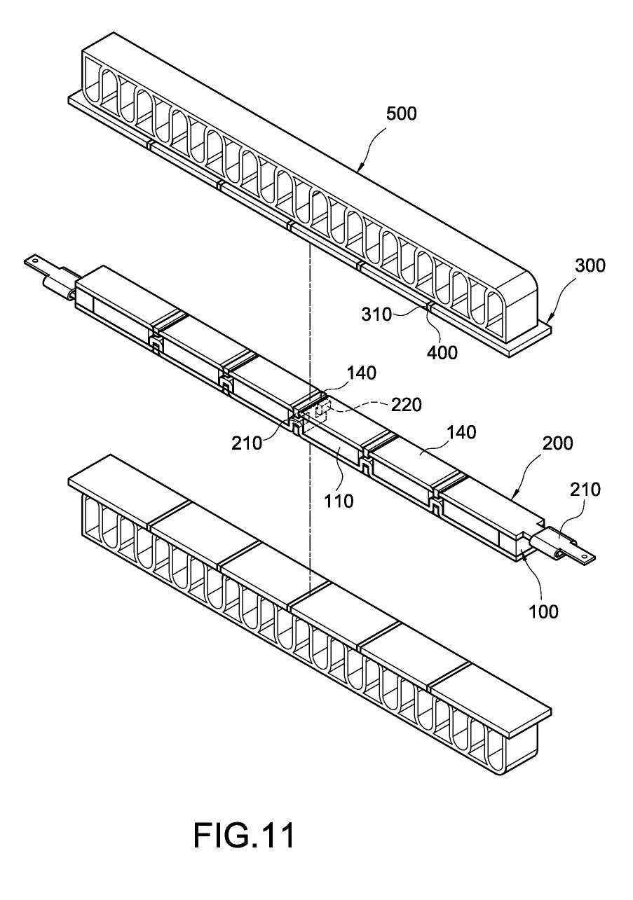

On the other hand, in order to enhance the insulating property and the structural strength of the heater, as shown in FIGS. 10 and 11, each of the insulating blocks 140 is sandwiched between two adjacent PCT ceramic heating pieces 110 to correspond to the seam 310 for supporting the insulating pieces 300. In the present embodiment, the cross section of the insulating block 140 in its width direction is formed into an “I” shape. The pair of electrode plates 200 is recessed to form a narrowed section 220 to correspond to the insulating block 140. The narrowed sections 220 are connected in series on both sides of the insulating block 140, thereby preventing from generating a short circuit.

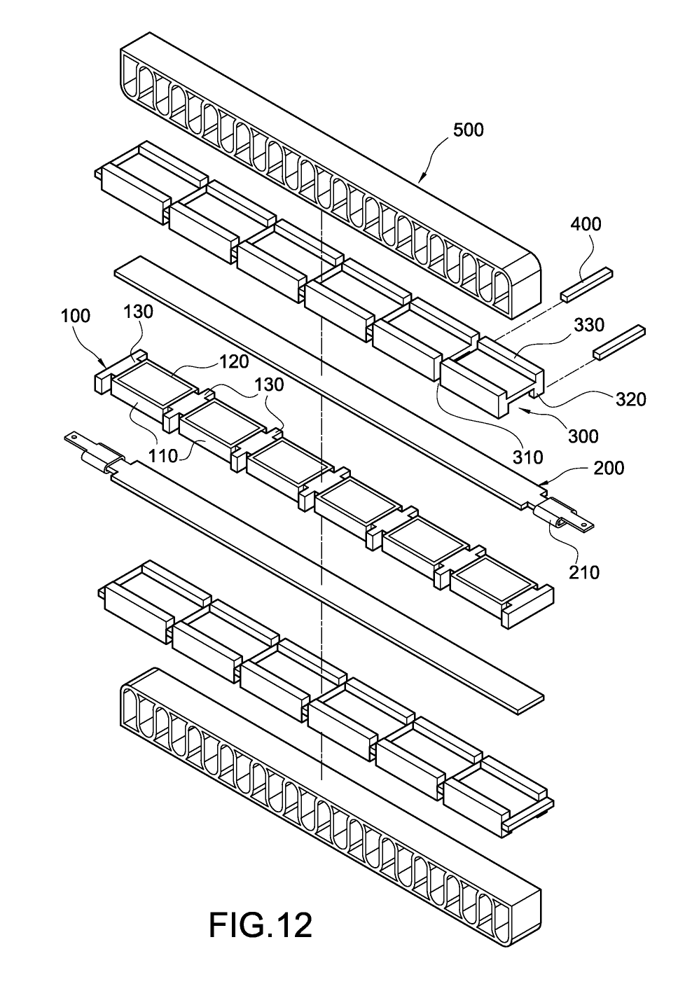

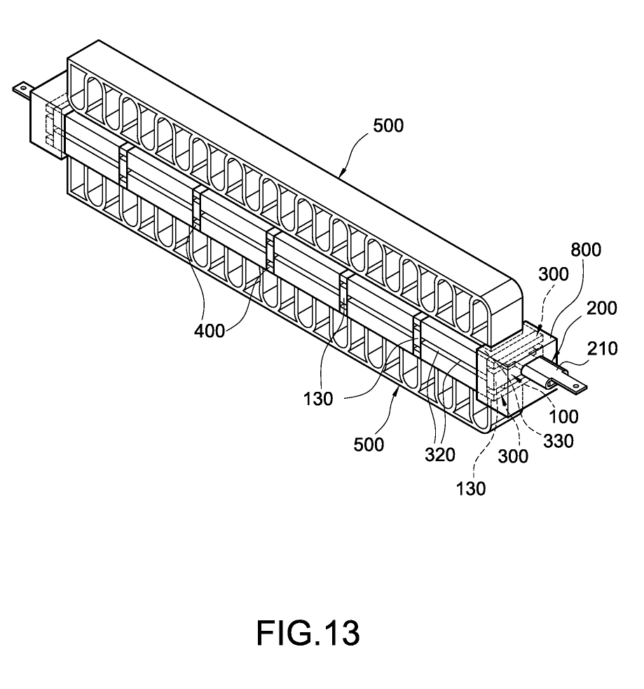

Please refer to FIGS. 12 and 13. One surface of the insulating piece 300 is formed with a pair of side walls 320. The pair of side walls 320 sandwiches the PTC ceramic heating pieces 110 and the electrode plate 200, thereby increasing the structural stability and the insulating property of the heater. The side walls 320 of one of the electrode plates 200 abut the side walls 320 of the other electrode plate 200. Alternatively, the side walls 320 of one of the electrode plates 200 do not abut the side walls 320 of the other electrode plate 200. The other surface of the insulating piece 300 protrudes to form a pair of positioning portions 330. The pair of positioning portions 330 sandwiches the fins 500 to enhance the structural stability of the whole heater.

Please refer to FIG. 13. The finned ceramic heater further includes a pair of insulating end cover 800. The insulating end cover 800 covers the ceramic heating assembly 100, the pair of electrode plates 200, and the distal ends of the insulating pieces 300. With this arrangement, the insulating property of the whole structure can be enhanced.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A finned ceramic heater, comprising:
a ceramic heating assembly;
a pair of electrode plates adhered to two side surfaces of the ceramic heating assembly;
a plurality of insulating pieces connected in series and adhered to outer surfaces of the pair of electrode plates respectively, a seam being formed between two adjacent insulating pieces, the width of the insulating piece being larger than that of the electrode plate;
an insulating adhesive filled in the seam; and
a pair of fins disposed on the insulating pieces and the insulating adhesive.

2. The finned ceramic heater according to claim 1, further comprising an insulating glue for covering the ceramic heating assembly, the pair of electrode plates, and the periphery of the insulating pieces.

3. The finned ceramic heater according to claim 1, further comprising an insulating frame for covering the ceramic heating assembly, the pair of electrode plates, and the periphery of the insulating pieces.

4. The finned ceramic heater according to claim 1, further comprising an insulating end cover for covering the ceramic heating assembly, the pair of electrode plates, and distal ends of the insulating pieces.

5. The finned ceramic heater according to claim 1, wherein the ceramic heating assembly comprises a plurality of positive temperature coefficient (PTC) ceramic heating pieces connected in series.

6. The finned ceramic heater according to claim 5, wherein the ceramic heating assembly further comprises an electrode layer coated on one side of the PTC ceramic heating pieces and located between the PTC ceramic heating pieces and the electrode plate.

7. The finned ceramic heater according to claim 6, wherein the electrode plate is an aluminum plate, and the electrode layer is an aluminum layer.

8. The finned ceramic heater according to claim 5, wherein the ceramic heating assembly further comprising an insulating gel filled between two adjacent PCT ceramic heating pieces.

9. The finned ceramic heater according to claim 5, wherein the ceramic heating assembly further comprises an insulating block adhered to one end of the PCT ceramic heating piece, and the comparative tracking index (CTI) of the insulating block is not less than 600.

10. The finned ceramic heater according to claim 5, wherein the ceramic heating assembly further comprises an “I”-shape insulating block positioned corresponding to the seam and sandwiched between two adjacent PCT ceramic heating pieces, and the comparative tracking index (CTI) of the insulating block is not less than 600.

11. The finned ceramic heater according to claim 10, wherein the pair of electrode plates is respectively formed with a narrowed section corresponding to the insulating block, the pair of narrowed sections penetrates the insulating block.

12. The finned ceramic heater according to claim 1, wherein the pair of electrode plates has an electrical conductive terminal extending in opposite directions.

13. The finned ceramic heater according to claim 5, wherein the insulating piece is formed with a pair of side walls for sandwiching the PTC ceramic heating piece and the electrode plate.

14. The finned ceramic heater according to claim 5, wherein the insulating piece is formed with a pair of positioning portions for sandwiching the fin.

15. The finned ceramic heater according to claim 1, wherein an end surface of the insulating piece is a vertical surface, the vertical end surfaces of two adjacent insulating pieces are connected to each other by the insulating adhesive.

16. The finned ceramic heater according to claim 1, wherein an end surface of the insulating piece is an inclined surface, the inclined end surfaces of two adjacent insulating pieces are connected to each other by the insulating adhesive.

17. The finned ceramic heater according to claim 1, wherein an end surface of the insulating piece is a stepped surface, the stepped end surfaces of two adjacent insulating pieces are connected to each other by the insulating adhesive.
